(19) United States
(12) Patent Application Publication
(10) Pub. No.: US 2021/0044509 A1
(43) Pub. Date: Feb. 11, 2021

(54) Intelligent Edge Gateway Device with Path and Response Time Optimization

(71) Applicant: Charter Communications Operating, LLC, St. Louis, MO (US)

(72) Inventor: James Brown, Broomfield, CO (US)

(73) Assignee: Charter Communications Operating, LLC, St. Louis, MO (US)

(21) Appl. No.: 16/531,355

(22) Filed: Aug. 5, 2019

(51) Int. Cl. H04L 12/26; H04L 12/66; H04L 29/08

(52) U.S. Cl. CPC H04L 43/08; H04L 67/18; H04L 67/2842; H04L 12/66

(57) ABSTRACT

Methods and systems for optimized communication path and response time selection of a computing system resource are described herein. In an implementation, a method includes receiving, at an edge gateway device from a requesting device, a service request. The edge gateway device requests from an endpoint tracker server, computing system resource locations which are responsive to the service request. Round-trip response times are computed for computing system resources for each received computing system resource location. The service request is directly sent to a computing system resource location with minimum round-trip response time, wherein a round-trip response time is a combination of communication path length and computing system resource response time. Round-trip response times are maintained and updated for future service requests.

### TECHNICAL FIELD

This disclosure relates to accessing computing system resources. More specifically, this disclosure relates to a method for selecting a computing system resource amongst multiple computing system resources.

### BACKGROUND

Many large enterprises have complex service offerings that span a variety of computing system resources including cloud computing providers as well as traditional data centers. Selecting which computing system resource represents the best choice in response to a service request is a challenge. This becomes even more complex when considering the duplication of services in environments where a cloud computing provider is used for “bursting”, i.e. automatically scaling up the resources used to respond to service requests that a static data center deployment is unable to meet.

Most solutions to this problem consider only the communication path when optimizing traffic. Such solutions depend on Border Gateway Protocol (BGP) or similar protocols to determine the optimum communication path to select the computing system resource. However, BGP is a layer 3 service in the Open Systems Interconnection model (OSI) stack which does not account for issues related to transmission and responsiveness of a computing system resource. This prevents BGP from being able to optimize requests based on the responsiveness of the computing system resource in any given location.

Consequently, this forces large enterprises or organizations to perform meticulous planning and testing of their service responsiveness from multiple client locations to optimize the client path. Moreover, the client may see reduced performance in cases where a communication or network path is short, but services are overloaded at the selected computing system resource to the point where the overall response time for a service request more than offsets the gains from the best network path. This may, in turn, require large organizations to replicate more infrastructure closer to each client to ensure best responsiveness.

Some solutions leverage anycast Internet Protocol (IP) addresses which are also used to create content delivery networks (CDNs). However, because these solutions also operate at layer 3 or at the edge of layer 4, the solutions have no awareness of service request-response times. These solutions are also limited by the fact that a single IP endpoint can be associated with only a single service, and therefore cannot provide the level of granularity necessary to differentiate between responses from hundreds of different services.

A challenge that arises is in planning the best communication path, as well as the most responsive communication path, for any given service request.

### SUMMARY

Disclosed herein are intelligent edge gateway devices for selecting computing system resources by optimizing communication path and response time. In an implementation, a method includes receiving, at an edge gateway device from a requesting device, a service request. The edge gateway device requests from an endpoint tracker server, which stores information for multiple providers having multiple computing system resource locations, a set of computing system resource locations which are responsive to the service request. The service request may include user preferences to reduce the amount of information shared with the edge gateway as well as the computing and network bandwidth demands created by testing multiple computing system resources to compute round-trip response time. Round-trip response times are computed for computing system resources for each received computing system resource location. The service request is directly sent to a computing system resource location with minimum round-trip response time, wherein a round-trip response time is a combination of communication path length and computing system resource response time. Round-trip response times are maintained and updated for future service requests.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example architecture with an intelligent edge gateway device in accordance with embodiments of this disclosure.

FIG. 2 is a diagram of an example architecture with an intelligent edge gateway device in accordance with embodiments of this disclosure.

FIG. 3 is a block diagram of an example of a device in accordance with embodiments of this disclosure.

FIG. 4 is a flowchart of an example method for optimized communication path and response time selection of a computing system resource in accordance with embodiments of this disclosure.

FIG. 5 is a flowchart of an example method for optimized communication path and response time selection of a computing system resource in accordance with embodiments of this disclosure.

FIG. 6 is a flowchart of an example method for optimized communication path and response time selection of a computing system resource in accordance with embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks or activities. For example, applications may perform one or more functions including, but not limited to, telephony, web browsers, e-commerce transactions, media players, travel scheduling and management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein are methods, devices, and systems for selection of a computing system resource(s) based on communication path and response time. An edge gateway device may obtain computing system resource locations based on service requests and if appropriate, user preferences. Response time testing to each computing system resource location may be performed to account for capabilities and capacity of each computing system resource location to perform the service request. Round-trip or transit times for each computing system resource location may be combined with the response times to calculate response round-trip times for each computing system resource location. The edge gateway device may then forward the service request to the computing system resource location having a minimum response round-trip time.

In an implementation, the edge gateway device may perform periodic requests of used or identified computing system resource locations to compute average response round-trip times, which would include both network latency and computing system resource response times. The edge gateway device may then optimally route service requests or traffic based on changing network and computing system resource conditions.

In an implementation, the edge gateway device may periodically check the processing times for various routes to each computing system resource location and the health of the computing system resource at each location. These results may be stored in local memory. The edge gateway device may refer to these results the next time a client makes a service request for similar services to leverage the optimal response round-trip time. Consequently, computing system resource service providers may provide improved access to their computing system resource locations by using the optimization provided by the edge gateway device.

In an implementation, the edge gateway device may be implemented in a regional data center (to minimize latency between the user or client and the edge gateway gateway), in an edge location such as a compute platform within a headend location of an Internet, cable, satellite, or like service provider, or integrated with a cable modem or like device.

In an implementation, the edge gateway device may share the response round-trip times for computing system resource locations with other edge gateway devices to reduce unnecessary network congestion related to the optimization process. In an implementation, the edge gateway devices may be similarly situated in terms of location, access to a common headend, or the like. In an implementation, the sharing or remote updating may be done on a periodic basis. The sharing may be communicated using a variety of communication protocols, including but not limited to, HyperText Transfer Protocol (HTTP), Hypertext Transfer Protocol Secure (HTTPS), Lightweight Directory Access Protocol (LDAP), and the like.

In an implementation, the edge gateway device may cache static data to further optimize response time and reduce network congestion. For example, the edge gateway device may operate as a small data-set content data or delivery network (CDN) that reduces low-latency responses from a traditional CDN from tens of milliseconds to one millisecond or less.

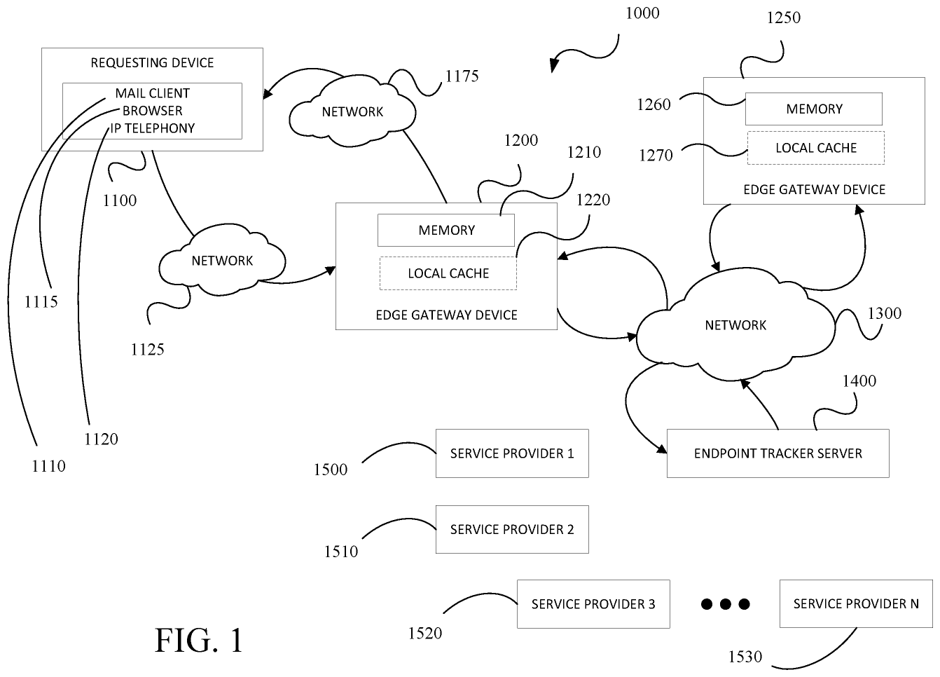

FIG. 1 is a diagram of an example architecture 1000 using an edge gateway device 1200 in accordance with embodiments of this disclosure. In an implementation, the architecture 1000 may include a requesting device 1100 connected to or in communication with (collectively “connected to”) an edge gateway device 1200. In an implementation, the connection between the requesting device 1100 and the edge gateway device 1200 may be through a network 1125 and a network 1175, where network 1125 and a network 1175 may be one network. The edge gateway device 1200 is connected to a network 1300, which in turn is connected to an endpoint tracker server 1400. The endpoint tracker server 1400 may track one or more service providers such as service provider 1 1500, service provider 2 1510, service provider 3 1520, and/or service provider N 1530. For example, each of the one or more service providers may request or agree to a listing on the endpoint tracker server 1400 and may then provide a service provider endpoint which is maintained by the endpoint tracker server 1400. The connections between the requesting device 1100, the edge gateway device 1200, the network 1300 and the endpoint tracker server 1400 may wired, wireless or a combination thereof, and may or may not be made through a network. In an implementation, one or more edge gateway devices 1250 may be connected to the endpoint tracker server 1400 via the network 1300, where one or more requesting devices (not shown) may send service requests to the one or more edge gateway devices 1250 for execution by the service providers such the service provider 1 1500, service provider 2 1510, service provider 3 1520, and/or service provider N 1530. The architecture 1000 is illustrative and may include additional, fewer or different devices, entities and the like which may be similarly or differently architected without departing from the scope of the specification and claims herein. Moreover, the illustrated devices may perform other functions without departing from the scope of the specification and claims herein.

The requesting device 1100 may be, but is not limited to, end user devices, set-top boxes, personal computers (PCs), cellular telephones, Internet Protocol (IP) devices, computers, desktop computers, laptops, mobile devices, handheld computers, PDAs, personal media devices, smartphones, notebooks, notepads, phablets and the like. For example, in an implementation, the requesting device 1100 may include applications such as, but not limited to, a mail application 1110, a web browser application 1115, an IP telephony application 1120 and the like.

The edge gateway device 1200 may be, but is not limited to, a router, Internet Service Provider (ISP) system device, access point device, network device, cable modem, and the like. In an implementation, the edge gateway device 1200 may include a memory 1210. In an implementation, the edge gateway device 1200 may include a local cache 1220. The memory 1210 and/or the local cache 1220 may be configured to store computing system resource locations, network latency or communication path times, response or processing times, round-trip response times, user preferences, computing system resource capabilities, service request type, and the like (collectively “resource selection information” when appropriate). As described herein, the resource selection information may be used by the edge gateway device 1200 to forward a service request to a computing system resource location which has a minimum round-trip response time. In an implementation, the resource selection information may be updated on a periodic basis. In an implementation, the resource selection information may be updated based on usage. In an implementation, the resource selection information may be updated based on pattern of usage. In an implementation, the resource selection information may be shared with other edge gateway devices such as edge gateway device 1250, for example. In an implementation, the resource selection information may be shared with edge gateway devices which may access the computing system resource locations from a common device such as endpoint tracker server 1400, for example. The local cache 1220 may be configured to store static data and the edge gateway device 1200 may accordingly operate as a CDN. The description herein may be equally applicable to the edge gateway device 1250.

The endpoint tracker server 1400 may track a plurality of service providers such as, but not limited to, service provider 1 1500, service provider 2 1510, service provider 3 1520, and service provide N 1530, where each service provider 1 1500 may include plurality of computing system resource locations. The endpoint tracker server 1400 aggregates the service provider information and provides relevant service provider information to requesting edge gateway devices. In an implementation, the endpoint tracker server 1400 facilitates sharing of the resource selection information between similarly situated edge gateway devices. In an implementation, the edge gateway device 1200 and the endpoint tracker server 1400 may be an integrated device.

The service providers such as, but not limited to, service provider 1 1500, service provider 2 1510, service provider 3 1520, and service provide N 1530 may provide service offerings which span multiple clouds, data centers, and the like. Each service provider may offer similar or different computing and/or storage capabilities and capacities. In an implementation, a service provider may handle certain service request types more efficiently than other service providers.

The network 1125, network 1175 and the network 1300 may be, but is not limited to, the Internet, an intranet, a local area network (LAN), a wide area network (WAN), a public network, a private network, a cellular network, a WiFi-based network, a telephone network, a landline network, public switched telephone network (PSTN), a wireless network, a wired network, a private branch exchange (PBX), a Integrated Services Digital Network (ISDN), a IP Multimedia Services (IMS) network, a Voice over Internet Protocol (VoIP) network, and like including any combinations thereof. In an implementation, each network 1125, 1175 and 1300 may contain one or more servers, network elements or devices, and the like.

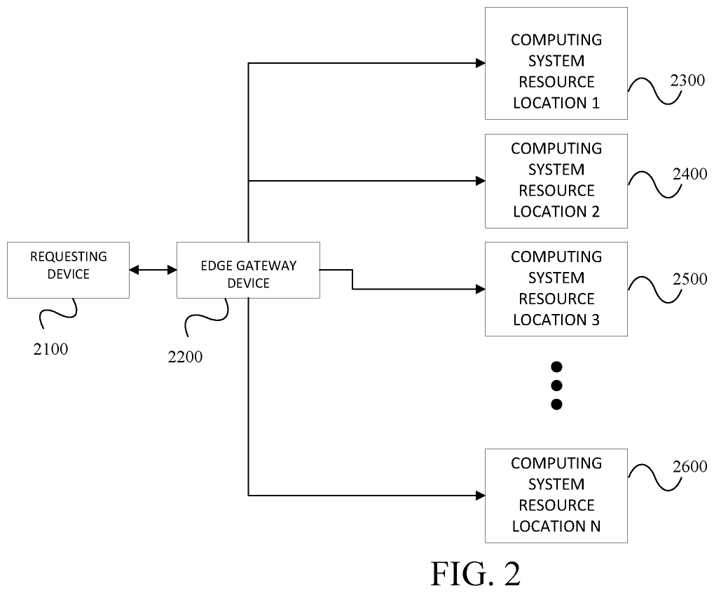

FIG. 2 is a diagram of an example architecture 2000 with an intelligent edge gateway device 2200 in accordance with embodiments of this disclosure. In an implementation, the architecture 2000 may include a requesting device 2100 connected to an edge gateway device 2200. In an implementation, the connection between the requesting device 2100 and the edge gateway device 2200 may be through a network (as shown in FIG. 1). The edge gateway device 2200 is connected to one or more computing system resource locations which are associated with a service provider such as, but not limited to, the service provider 1 1500, the service provider 2 1510, the service provider 3 1520, and the service provide N 1530. The one or more computing system resource locations may include, but are not limited to, computing system resource location 1 2300, computing system resource location 2 2400, computing system resource location 3 2500, and/or computing system resource location N 2600, for example. In an implementation, the connection between the edge gateway device 2200 and the computing system resource location 1 2300, the computing system resource location 2 2400, the computing system resource location 3 2500, and/or the computing system resource location N 2600 may be through a network. The connections between the requesting device 2100, the edge gateway device 2200, and the computing system resource location 1 2300, the computing system resource location 2 2400, the computing system resource location 3 2500, and/or the computing system resource location N 2600 may be wired, wireless or a combination thereof, and may or may not be made through a network. The architecture 2000 is illustrative and may include additional, fewer or different devices, entities and the like which may be similarly or differently architected without departing from the scope of the specification and claims herein. Moreover, the illustrated devices may perform other functions without departing from the scope of the specification and claims herein.

The requesting device 2100 may be, but is not limited to, end user devices, set-top boxes, personal computers (PCs), cellular telephones, Internet Protocol (IP) devices, computers, desktop computers, laptops, mobile devices, handheld computers, PDAs, personal media devices, smartphones, notebooks, notepads, phablets and the like. For example, in an implementation, the requesting device 2100 may include applications as described in FIG. 1.

The edge gateway device 2200 may be, but is not limited to, a router, Internet Service Provider (ISP) system device, access point device, network device, cable modem, and the like. In an implementation, the edge gateway device 2200 may include a memory and/or a cache as shown in FIG. 1. In an implementation, the edge gateway device 2200 may operate and/or function as described with respect to FIG. 1.

The computing system resource location 1 2300, the computing system resource location 2 2400, the computing system resource location 3 2500, and/or the computing system resource location N 2600 may each have computing system resources which are able to perform the service request. In an implementation, each of the computing system resources at the computing system resource location 1 2300, the computing system resource location 2 2400, the computing system resource location 3 2500, and/or the computing system resource location N 2600 may have similar capabilities in terms of processing capability, storage capability, applications, architecture, and the like. In an implementation, each of the computing system resources of the computing system resource location 1 2300, the computing system resource location 2 2400, the computing system resource location 3 2500, and/or the computing system resource location N 2600 may each have different capabilities in terms of processing capability, storage capability, applications, architecture, and the like. In an implementation, the computing system resources of a computing system resource location may handle certain service request types more efficiently than other computing system resources at other computing system resource locations.

Operationally, with reference to FIGS. 1 and 2, the requesting device 1100 (2100) may sends a service request using the mail application 1110, the web browser application 1115, or the IP telephony application 1120, for example, to the edge gateway device 1200 (2200). In an implementation, the service request may be sent via network 1125. In an implementation, the service request may include user preferences. The edge gateway device 1200 may receive and check the service request and any applicable user preferences against stored resource selection information. If the service request and any applicable user preferences matches a stored resource selection information, then the edge gateway device 1200 may forward the service request to the applicable computing system resource location which has the minimum round-trip response time. If a match does not exist, the edge gateway device 1200 may send a request to the endpoint tracker server 1400 for computing system resource locations that match the service request and any applicable user preferences. The edge gateway device 1200 may then execute test requests against each of the computing system resources at the computing system resource locations provided by the endpoint tracker server 1400. In an implementation, the test messages may include a variety of test messages to exercise the computing system resource. In an implementation, a test message may be similar to the service request. In this fashion, the computing system resource which perform the best for a particular type of service request may be made available. The edge gateway device 1200 may then send the service request to the computing system resource location which has the minimum round-trip response time. Table 1 represents an illustrative example where the service request may be sent to computing system resource location 1 whereas computing system resource location 3 has the smallest network latency and computing system resource location 1 has the greatest network latency.

TABLE 1

| | | Computing | | | | |
|---|---|---|---|---|---|---|
| | | System | | Total | | |
| | Network | Resource | | response | | Optimal |
| | latency | Processing | | round | Optimal | response |
| Location | (ms) | time (ms) | | trip time | latency | time |
| Computing | 40 ms | 30 | ms | 110 ms | | X |
| System | | | | (40 + 40 | | |
| Resource | | | | for round | | |
| Location 1 | | | | trip time + | | |
| | | | | 30 ms) | | |
| Computing | 30 ms | 60 | ms | 120 ms | | |
| System | | | | | | |
| Resource | | | | | | |
| Location 2 | | | | | | |
| Computing | 20 ms | 120 | ms | 160 ms | X | |
| System | | | | | | |
| Resource | | | | | | |
| Location 3 | | | | | | |

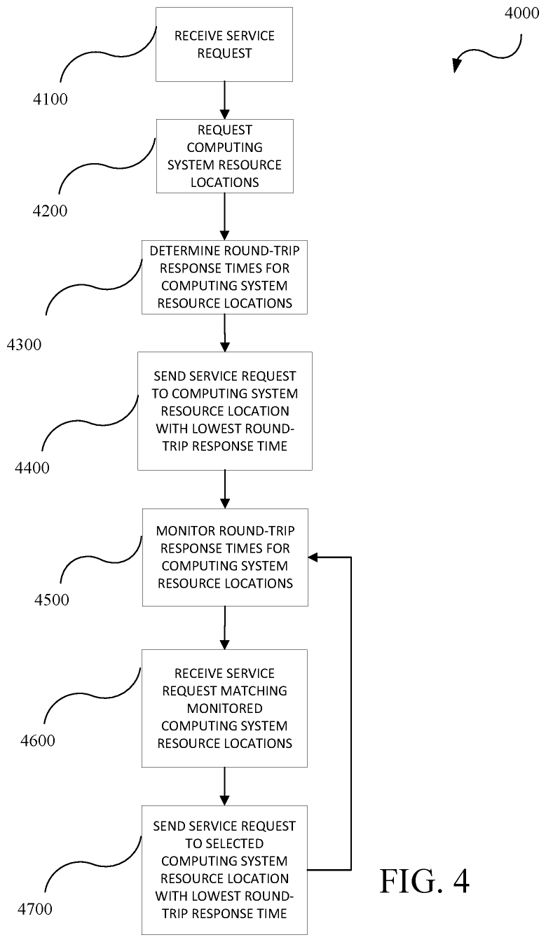

In an implementation, the resource selection information may be periodically updated by the edge gateway device 1200 by running the test messages. In an implementation, depending on usage or patterns of usage, the resource selection information may be updated by the edge gateway device 1200 by running the test messages. The edge gateway device 1200, by using one or more of the techniques described with respect to FIGS. 4-6, may provide optimum round-trip response time for a given service request.

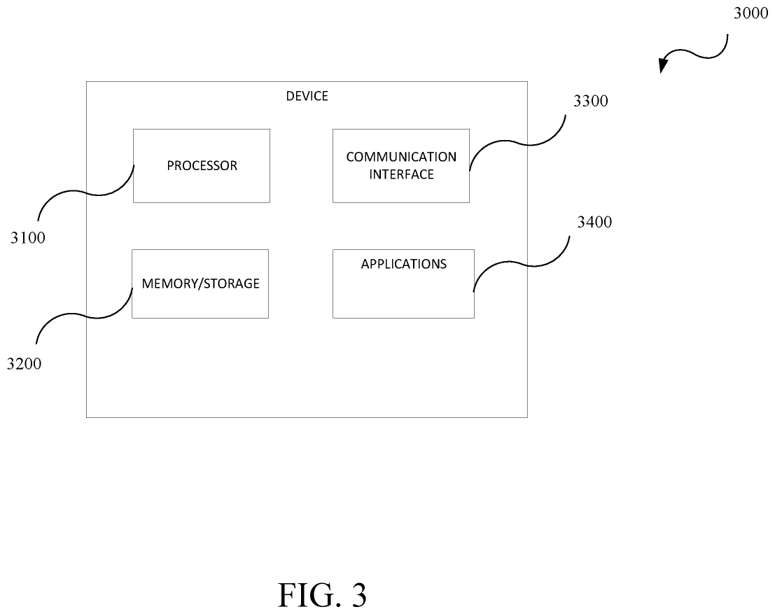

FIG. 3 is a block diagram of an example of a device 3000 in accordance with embodiments of this disclosure. The device 3000 may include, but is not limited to, a processor 3100, a memory/storage 3200, a communication interface 3300, and applications 3400. The device 3000 may include or implement, for example, the requesting device 1100 and 2100, the edge gateway device 1200, 1250, and 2200, the endpoint tracker server 1400, and the computing system resources at each computing system resource location 2300, 2400, 2500, and 2600, for example. In an implementation, the memory/storage 3200 may include the local cache 1220 or 1270, as applicable, and store the resource selection information and/or static data as applicable. The optimized communication path and response time selection of a computing system resource techniques or methods described herein may be stored in the memory/storage 3200 and executed by the processor 3100 in cooperation with the memory/storage 3200, the communications interface 3300, and applications 3400, as appropriate. The device 3000 may include other elements which may be desirable or necessary to implement the devices, systems, compositions and methods described herein. However, because such elements and steps are well known in the art, and because they do not facilitate a better understanding of the disclosed embodiments, a discussion of such elements and steps may not be provided herein.

FIG. 4 is a flowchart of an example method 4000 for optimized communication path and response time selection of a computing system resource in accordance with embodiments of this disclosure. The method 4000 includes: receiving 4100 a service request; requesting 4200 computer system resource locations; determining 4300 round-trip response times for received computer system resource locations; sending 4400 the service request to computer system resource location with minimum round-trip response time; monitoring 4500 round-trip response times for computer system resource locations; receiving 4600 a service request matching a computer system resource location; and sending 4700 the service request to the computer system resource location with minimum round-trip response time. For example, the method 4000 may be implemented, as applicable and appropriate, by the requesting device 1100 of FIG. 1, the edge gateway device 1200 of FIG. 1, the endpoint tracker server 1400 of FIG. 1, the requesting device 2100 of FIG. 2, the edge gateway device 2200 of FIG. 2, the computing system resources of each of computing system resource location 2300, 2400, 2500, and 2600 of FIG. 2, the device 3000 of FIG. 3 and the processor 3100 of FIG. 3.

The method 4000 includes receiving 4100 a service request. For example, but not limited to, service requests may require computational resources, storage resources, media resources, combinations thereof, and the like. In an implementation, the service request may include user preferences. For example, the user preferences may be for a particular service provider, a computing system resource architecture, geographic locations, service provider size, and/or like characteristic(s) or feature(s).

The method 4000 includes requesting 4200 computer system resource locations. The edge gateway device sends a request to an endpoint tracker server or like device for a list of computing system resource locations. In an implementation, the request may include the service request type, user preferences, or the like.

The method 4000 includes determining 4300 round-trip response times for received computer system resource locations. For each computing system resource location received from the endpoint tracker server, the edge gateway device may determine a network latency time, a computing system resource processing time, and a round-trip response time which is a combination of the network latency time and the processing time. In an implementation, the combination may be a weighted combination where one of the network latency time or the processing time may have a greater weight. For example, a type of computing system resource architecture may carry more weight than network latency. The determining 4300 may include sending a test message to each computing system resource location to determine a computing system resource processing time. In an implementation, different test messages may be used to exercise different aspects of the computing system resource. In an implementation, the test message may reflect the service request. In an implementation, the testing may include exercising a defined number of resources at the computing system resource location to obtain resource processing times for each of the defined number of resources and compute a mean resource processing time.

The method 4000 includes sending 4400 the service request to computer system resource location with minimum round-trip response time. The edge gateway device forwards the service request directly to the computing system resource location which has the lowest combined network latency time and processing time. In an implementation, the sending 4400 may include establishing a connection between the requesting device and the computing system resource at the computing system resource location. In an implementation, the connection may or may not include the edge gateway device once the service request is forwarded. In an implementation, once a session with a computing system resource at the selected computer resource location has begun, the service request may be pinned to that computing system resource until the session is completed so that any state information may be preserved or retained that may be unique to the session and the computing system resource across the connections.

The method 4000 includes monitoring 4500 round-trip response times for computer system resource locations. For computer system resource locations already known by the edge gateway device, updated network latency and computer system resource processing times may be periodically updated in the event of future service requests. In an implementation, the periodicity may be based on usage of the computer system resource location. In an implementation, the periodicity may be based on usage patterns of the computer system resource location. In an implementation, the periodicity may be based on frequency of service requests. In an implementation, the periodicity may be based on timing of service requests. In an implementation, machine learning techniques may be used to determine behavior patterns with respect to the service requests, computer system resource locations, and/or combinations thereof. In an implementation, certain computer system resource locations may not be updated due to non-use or predicted non-use. In an implementation, certain computer system resource locations may be deleted from the edge gateway device due to non-use or predicted non-use. In an implementation, certain computer system resource locations may be aged-out.

The method 4000 includes receiving 4600 a service request matching a computer system resource location. For example, but not limited to, service requests may require computational resources, storage resources, media resources, combinations thereof, and the like which are being monitored by the edge gateway device. The edge gateway device compares the service request against stored resource selection information. In an implementation, matching may include, user preferences, computing system resource type, previous usage, and the like.

The method 4000 includes sending 4700 the service request to the computer system resource location with minimum round-trip response time. In this instance, the edge gateway device forwards the service request to the matching computer system resource location having the least round-trip response time. In an implementation, the sending 4700 may include establishing a connection between the requesting device and the computing system resource at the computing system resource location. In an implementation, the connection may or may not include the edge gateway device once the service request is forwarded.

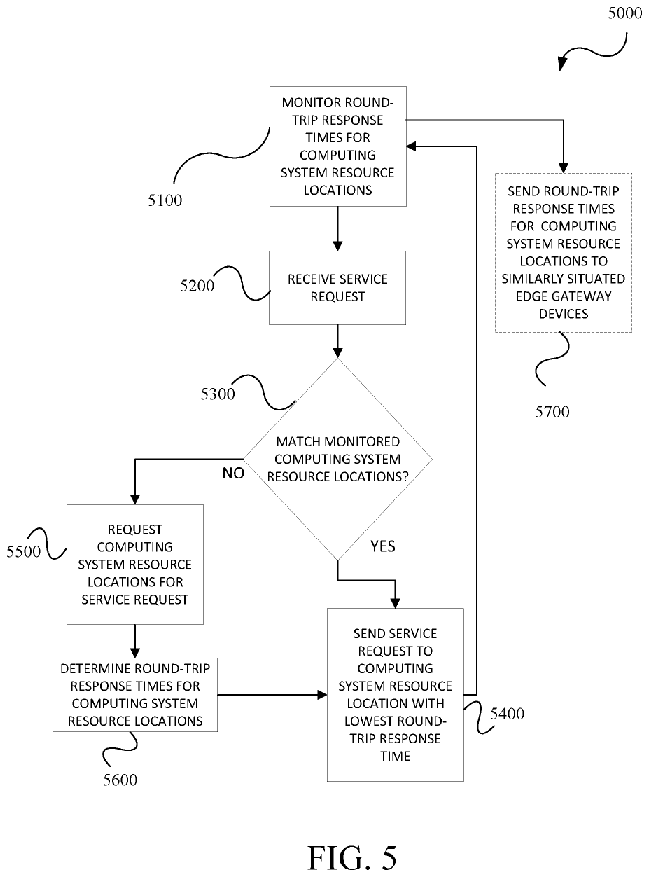

FIG. 5 is a flowchart of an example method or technique 5000 for optimized communication path and response time selection of a computing system resource in accordance with embodiments of this disclosure. The method 5000 includes: monitoring 5100 round-trip response times for computer system resource locations; receiving 5200 a service request; determining 5300 whether the service request matches any of the monitored computer system resource locations; sending 5400 the service request to matching computing system resource location with lowest round-trip response time; requesting 5500 computer system resource locations if no matching monitored computer system resource locations; determining 5600 round-trip response times for received computer system resource locations; and sending 5400 the service request to computer system resource location with minimum round-trip response time. In an implementation, the method 5000 may include sending 5700 round-trip response times for computer system resource locations to similarly situated edge gateway devices. For example, the method 5000 may be implemented, as applicable and appropriate, by the requesting device 1100 of FIG. 1, the edge gateway device 1200 of FIG. 1, the endpoint tracker server 1400 of FIG. 1, the requesting device 2100 of FIG. 2, the edge gateway device 2200 of FIG. 2, the computing system resources of each of computing system resource location 2300, 2400, 2500, and 2600 of FIG. 2, the device 3000 of FIG. 3 and the processor 3100 of FIG. 3.

The method 5000 includes monitoring 5100 round-trip response times for computer system resource locations. For computer system resource locations already known by the edge gateway device, updated network latency and computer system resource processing times may be periodically updated in the event of future service requests. In an implementation, the periodicity may be based on usage of the computer system resource location. In an implementation, the periodicity may be based on usage patterns of the computer system resource location. In an implementation, the periodicity may be based on frequency of service requests. In an implementation, the periodicity may be based on timing of service requests. In an implementation, machine learning techniques may be used to determine behavior patterns with respect to the service requests, computer system resource locations, and/or combinations thereof. In an implementation, certain computer system resource locations may not be updated due to non-use or predicted non-use. In an implementation, certain computer system resource locations may be deleted from the edge gateway device due to non-use or predicted non-use. The monitoring 5100 may include receiving a service request, requesting computer system resource locations, determining round-trip response times for received computer system resource locations, and sending the service request to computer system resource location with minimum round-trip response time as described herein.

The method 5000 includes receiving 5200 a service request. For example, but not limited to, service requests may require computational resources, storage resources, media resources, combinations thereof, and the like. In an implementation, the service request may include user preferences. In an implementation, the user preference includes at least a particular service provider. In an implementation, the user preference includes a particular service provider, a computing system resource architecture, geographic locations, service provider size, and/or like characteristic(s) or feature(s), solely and in combinations thereof.

The method 5000 includes determining 5300 whether the service request matches any of the monitored computer system resource locations. For example, but not limited to, the service request may require computational resources, storage resources, media resources, combinations thereof, and the like which are being monitored by the edge gateway device. The edge gateway device compares the service request against stored resource selection information. In an implementation, matching may include, user preferences, computing system resource type, previous usage, and the like.

The method 5000 includes sending 5400 the service request to matching computing system resource location with lowest round-trip response time. In this instance, the edge gateway device forwards the service request to the matching computer system resource location having the least round-trip response time. In an implementation, the sending 5400 may include establishing a connection between the requesting device and the computing system resource at the computing system resource location. In an implementation, the connection may or may not include the edge gateway device once the service request is forwarded.

The method 5000 includes requesting 5500 computer system resource locations if no matching monitored computer system resource locations. The edge gateway device sends a request to an endpoint tracker server or like device for a list of computing system resource locations. In an implementation, the request may include the service request type, user preferences, or the like.

The method 5000 includes determining 5600 round-trip response times for received computer system resource locations. For each computing system resource location received from the endpoint tracker server, the edge gateway device may determine a network latency time, a computing system resource processing time, and a round-trip response time which is a combination of the network latency time and the processing time. In an implementation, the combination may be a weighted combination where one of the network latency time or the processing time may have a greater weight. For example, a type of computing system resource architecture may carry more weight than network latency. The determining 5600 may include sending a test message to each computing system resource location to determine a computing system resource processing time. In an implementation, different test messages may be used to exercise different aspects of the computing system resource. In an implementation, the test message may reflect the service request.

The method 5000 includes sending 5400 the service request to computer system resource location with minimum round-trip response time as described herein.

The method 5000 includes sending 5700 round-trip response times for computer system resource locations to similarly situated edge gateway devices. In an implementation, an edge gateway device may share the stored resource selection information. In an implementation, the edge gateway devices may be similarly situated in terms of location, access to a common headend, or the like. In an implementation, the sharing or remote updating may be done on a periodic basis. The sharing may be communicated using a variety of communication protocols, including but not limited to, HTTP, HTTPS, LDAP, and the like.

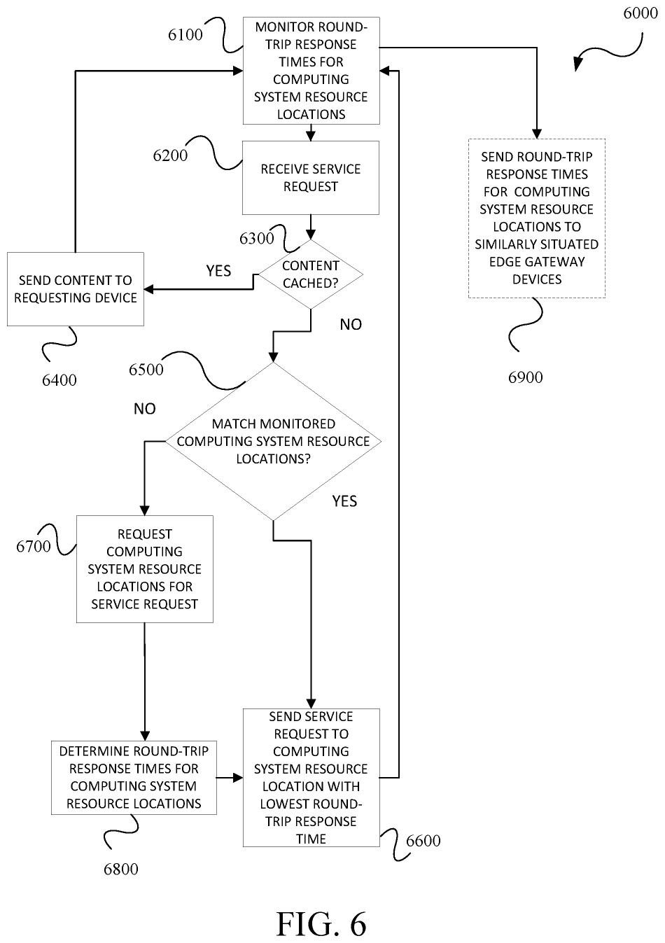

FIG. 6 is a flowchart of an example method 6000 for optimized communication path and response time selection of a computing system resource in accordance with embodiments of this disclosure. The method 6000 includes: monitoring 6100 round-trip response times for computer system resource locations; receiving 6200 a service request; determining 6300 if content is cached responsive to the service request; sending 6400 cached content if available; determining 6500 whether the service request matches any of the monitored computer system resource locations; sending 6600 the service request to matching computing system resource location with lowest round-trip response time; requesting 6700 computer system resource locations if no matching monitored computer system resource locations; determining 6800 round-trip response times for received computer system resource locations; and sending 6600 the service request to computer system resource location with minimum round-trip response time. In an implementation, the method 6000 may include sending 6900 round-trip response times for computer system resource locations to similarly situated edge gateway devices. For example, the technique 6000 may be implemented, as applicable and appropriate, by the requesting device 1100 of FIG. 1, the edge gateway device 1200 of FIG. 1, the endpoint tracker server 1400 of FIG. 1, the requesting device 2100 of FIG. 2, the edge gateway device 2200 of FIG. 2, the computing system resources of each of computing system resource location 2300, 2400, 2500, and 2600 of FIG. 2, the device 3000 of FIG. 3 and the processor 3100 of FIG. 3.

The method 6000 includes monitoring 6100 round-trip response times for computer system resource locations. For computer system resource locations already known by the edge gateway device, network latency and computer system resource processing times may be periodically updated in the event of future service requests. In an implementation, the periodicity may be based on usage of the computer system resource location. In an implementation, the periodicity may be based on usage patterns of the computer system resource location. In an implementation, the periodicity may be based on frequency of service requests. In an implementation, the periodicity may be based on timing of service requests. In an implementation, machine learning techniques may be used to determine behavior patterns with respect to the service requests, computer system resource locations, and/or combinations thereof. In an implementation, certain computer system resource locations may not be updated due to non-use or predicted non-use. In an implementation, certain computer system resource locations may be deleted from the edge gateway device due to non-use or predicted non-use. The monitoring 6100 may include receiving a service request, requesting computer system resource locations, determining round-trip response times for received computer system resource locations, and sending the service request to computer system resource location with minimum round-trip response time as described herein.

The method 6000 includes receiving 6200 a service request. For example, but not limited to, service requests may require computational resources, storage resources, media resources, combinations thereof, and the like. In an implementation, the service request may include user preferences. For example, the user preferences may be for a particular service provider, a computing system resource architecture, geographic locations, service provider size, and/or like characteristic(s) or feature(s).

The method 6000 includes determining 6300 if content is cached responsive to the service request. For example, the edge gateway device may check a local cache for content responsive to the service request.

The method 6000 includes sending 6400 cached content if available.

The method 6000 includes determining 6500 whether the service request matches any of the monitored computer system resource locations if content is not cached. For example, but not limited to, the service request may require computational resources, storage resources, media resources, combinations thereof, and the like which are being monitored by the edge gateway device. The edge gateway device compares the service request against stored resource selection information. In an implementation, matching may include, user preferences, computing system resource type, previous usage, and the like.

The method 6000 includes sending 6600 the service request to matching computing system resource location with lowest round-trip response time. In this instance, the edge gateway device forwards the service request to the matching computer system resource location having the least round-trip response time. In an implementation, the sending 6600 may include establishing a connection between the requesting device and the computing system resource at the computing system resource location. In an implementation, the connection may or may not include the edge gateway device once the service request is forwarded.

The method 6000 includes requesting 6700 computer system resource locations if no matching monitored computer system resource locations. The edge gateway device sends a request to an endpoint tracker server or like device for a list of computing system resource locations. In an implementation, the request may include the service request type, user preferences, or the like.

The method 6000 includes determining 6800 round-trip response times for received computer system resource locations. For each computing system resource location received from the endpoint tracker server, the edge gateway device may determine a network latency time, a computing system resource processing time, and a round-trip response time which is a combination of the network latency time and the processing time. In an implementation, the combination may be a weighted combination where one of the network latency time or the processing time may have a greater weight. For example, a type of computing system resource architecture may carry more weight than network latency. The determining 6800 may include sending a test message to each computing system resource location to determine a computing system resource processing time. In an implementation, different test messages may be used to exercise different aspects of the computing system resource. In an implementation, the test message may reflect the service request.

The method 6000 includes sending 6600 the service request to computer system resource location with minimum round-trip response time as described herein.

The method 6000 includes sending 6900 round-trip response times for computer system resource locations to similarly situated edge gateway devices. In an implementation, an edge gateway device may share the stored resource selection information. In an implementation, the edge gateway devices may be similarly situated in terms of location, access to a common headend, or the like. In an implementation, the sharing or remote updating may be done on a periodic basis. The sharing may be communicated using a variety of communication protocols, including but not limited to, HTTP, HTTPS, LDAP, and the like.

In general, a method for optimized communication path and response time selection of a computing system resource, the method includes receiving, at an edge gateway device from a requesting device, a service request. The edge gateway device requests from an endpoint tracker server, the computing system resource locations which are responsive to the service request. The edge gateway device determines round-trip response times for computing system resources for each received computing system resource locations. The edge gateway device sends the service request directly to a computing system resource location with minimum round-trip response time, where a round-trip response time is a combination of communication path length and computing system resource response time. The edge gateway device monitors round-trip response times for the received computing system resource locations. The edge gateway device receives another service request matching a monitored computing system resource location and sends the another service request to the matching computing system resource location with minimum round-trip response time. In an implementation, the service request includes user preferences and the received computing system resource locations match the user preferences. In an implementation, the combination is a weighted combination of the communication path length and the computing system resource response time. In an implementation, the requesting computing system resource locations further includes sending, by the edge gateway device, at least one test message to each received computing system resource location. In an implementation, different test messages exercise different aspects of a computing system resource at each received computing system resource location. In an implementation, the at least one test message exercise reflects the service request. In an implementation, the method further includes sending, by the edge gateway device, monitored computing system resource locations to similarly situated devices. In an implementation, the monitored computing system resource locations are sent via the endpoint tracker server. In an implementation, similarly situated is at least one of geographic location and access to a common headend. In an implementation, the monitoring further includes periodically updating, by the edge gateway device, the monitored computing system resource locations. In an implementation, the monitoring further includes updating, by the edge gateway device, the monitored computing system resource locations based on frequency of service requests. In an implementation, the monitoring further includes updating, by the edge gateway device, the monitored computing system resource locations based on usage of monitored computing system resource location. In an implementation, the monitoring further includes removing, by the edge gateway device, a monitored computing system resource location based on usage.

In general, a method for optimized network latency and processing time selection of a service resource includes maintaining, by a gateway router, service times for service locations received in response to previous user requests, wherein a service time is a summation of network latency and processing time. The gateway router receives a user request. The gateway router sends the user request directly to a maintained service location with a minimum service time in the event of a successful match. The gateway router requests of a provider server, service locations which are responsive to the user request in the event of a failed match. The gateway router determines service times for resources at each received service location and sends the user request directly to a service location with minimum service time. In an implementation, the previous service requests and the service request include user preferences and the maintained service locations and received service locations match the user preferences. In an implementation, the method further includes caching, at the gateway router, static content data, and sending, by the gateway router, the static content data responsive to the user request in the event of a successful match. In an implementation, the requesting computing system resource locations further includes sending, by the gateway router, at least one test message to each received service location, where different test messages exercise different aspects of a computing system resource at each received computing system resource location, and where the at least one test message reflects the service request.

In an implementation, a system includes an endpoint tracker server configured to store information for multiple providers and computing system resource locations for each of the multiple providers, and an edge gateway device connected to the endpoint tracker server. The edge gateway device is configured to store round-trip response times for computing system resource locations received in response to previous service requests, where a round-trip response time is a summation of network latency and processing time. The edge gateway device is configured to send a service request directly to a maintained computing system resource location with a minimum round-trip response time in the event of a successful match with a service request. The edge gateway device is configured to request from the endpoint tracker server computing system resource locations which are responsive to the service request in the event of a failed match with the service request and send the service request directly to a computing system resource location with minimum round-trip response time. In an implementation, the previous service requests and the service request include user preferences and the stored computing system resource locations and the received computing system resource locations match the user preferences. In an implementation, the edge gateway device further configured to send at least one test message to each maintained computing system resource location and each received computing system resource location, where different test messages exercise different aspects of a computing system resource at each of the maintained computing system resource locations and the received computing system resource locations, and where the at least one test message reflects a service request.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

1. A method for optimized communication path and response time selection of a computing system resource, the method comprising:
receiving, at an edge gateway device from a requesting device, a service request;
requesting, by the edge gateway device from an endpoint tracker server, the computing system resource locations which are responsive to the service request;
determining, by the edge gateway device, round-trip response times for computing system resources for each received computing system resource locations;
sending, by the edge gateway device, the service request directly to a computing system resource location with minimum round-trip response time, wherein a round-trip response time is a combination of communication path length and computing system resource processing response time;
monitoring, by the edge gateway device, round-trip response times for the received computing system resource locations;
receiving, by the edge gateway device, another service request matching a monitored computing system resource location; and
sending, by the edge gateway device, the another service request to the matching computing system resource location with minimum round-trip response time.

2. The method of claim 1, wherein the service request includes user preferences and the received computing system resource locations match the user preferences.

3. The method of claim 1, wherein the combination is a weighted combination of the communication path length and the computing system resource processing response time.

4. The method of claim 1, wherein the requesting computing system resource locations further comprising:
sending, by the edge gateway device, at least one test message to each received computing system resource location.

5. The method of claim 4, wherein different test messages exercise different computing aspects of a computing system resource at each received computing system resource location.

6. The method of claim 4, wherein the at least one test message exercise reflects the service request.

7. The method of claim 1, further comprising:
sending, by the edge gateway device, monitored computing system resource locations to similarly situated edge gateway devices.

8. The method of claim 7, wherein the monitored computing system resource locations are sent via the endpoint tracker server.

9. The method of claim 7, wherein similarly situated is at least one of geographic location and access to a common headend.

10. The method of claim 1, wherein the monitoring further comprising:
periodically updating, by the edge gateway device, round-trip response times of the monitored computing system resource locations.

11. The method of claim 1, wherein the monitoring further comprising:
updating, by the edge gateway device, round-trip response times of the monitored computing system resource locations based on frequency of service requests.

12. The method of claim 1, wherein the monitoring further comprising:
updating, by the edge gateway device, round-trip response times of the monitored computing system resource locations based on usage of monitored computing system resource location.

13. The method of claim 1, wherein the monitoring further comprising:
removing, by the edge gateway device, a monitored computing system resource location based on usage.

14. A method for optimized network latency and processing time selection of a service resource, the method comprising:
maintaining, by a gateway router, service times for service locations received in response to previous user requests, wherein a service time is a summation of network latency and processing time;
receiving, by the gateway router, a user request;
sending, by the gateway router, the user request directly to a maintained service location with a minimum service time in the event of a successful match;
requesting, by the gateway router of a provider server, service locations which are responsive to the user request in the event of a failed match;
determining, by the gateway router, service times for resources at each received service location;
sending, by the router, the user request directly to a service location with minimum service time.

15. The method of claim 14, wherein the previous service requests and the service request include user preferences and the maintained service locations and received service locations match the user preferences.

16. The method of claim 14, further comprising:
caching, at the gateway router, static content data; and
sending, by the gateway router, the static content data responsive to the user request in the event of a successful match.

17. The method of claim 14, wherein the requesting computing system resource locations further comprising:
sending, by the gateway router, at least one test message to each received service location,
wherein different test messages exercise different aspects of a computing system resource at each received computing system resource location; and
wherein the at least one test message reflects the service request.

18. A system comprising:
an endpoint tracker server configured to store information for multiple providers and computing system resource locations for each of the multiple providers; and
an edge gateway device connected to the endpoint tracker server, the edge gateway device configured to:
store round-trip response times for computing system resource locations received in response to previous service requests, wherein a round-trip response time is a summation of network latency and processing time;
send a service request directly to a maintained computing system resource location with a minimum round-trip response time in the event of a successful match with a service request;
request from the endpoint tracker server computing system resource locations which are responsive to the service request in the event of a failed match with the service request; and
send the service request directly to a computing system resource location with minimum round-trip response time.

19. The system of claim 18, wherein the previous service requests and the service request include user preferences and the stored computing system resource locations and the received computing system resource locations match the user preferences.

20. The system of claim 18, wherein the edge gateway device further configured to:
send at least one test message to each maintained computing system resource location and each received computing system resource location,
wherein different test messages exercise different aspects of a computing system resource at each of the maintained computing system resource locations and the received computing system resource locations; and
wherein the at least one test message reflects a service request.
